(19) United States
(12) Patent Application Publication
(10) Pub. No.: US 2009/0251386 A1
(43) Pub. Date: Oct. 8, 2009

(54) MENU SHEET

(75) Inventors: Yoshihiko Ikeda, Shizuoka (JP); Hiroki Mochizuki, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/411,423

(22) Filed: Mar. 26, 2009

(30) Foreign Application Priority Data
Apr. 3, 2008 (JP) 2008-097443

(51) Int. Cl. G09G 3/00

(52) U.S. Cl. 345/30

(57) ABSTRACT

A base sheet has a menu surface for writing a menu. An information display section is attached to the base sheet and displays content of display data. A receiving section receives display data transmitted by an information transmitting apparatus. A storing section stores display data. A control section causes the storing section to store the display data received by the receiving section and causes the information display section to display the display data stored by the storing section.

### CROSS-REFERENCE TO RELATED APPLICATION

This application is based upon and claims the benefit of priority from Japanese Patent Application No. 2008-097443, filed on Apr. 3, 2008, the entire contents of which are incorporated herein by reference.

### TECHNICAL FIELD

The present invention relates to menu sheets that customers refer to in selecting order items in restaurants.

### BACKGROUND

In a menu sheet used in a restaurant, a menu is fixedly written by printing or handwriting. Therefore, for example, in order to inform customers of today's specials, employees in the restaurant pass another sheet on which the today's specials are written to the customers together with an usual menu sheet or set a sign showing the today's specials at an entrance or the like of the restaurant. An electronic menu terminal disclosed in JP-A-2007-140994 and an electronic menu terminal disclosed in JP-A-6-52193 cause customers to input order data using input devices (a button and a touch panel) with which the customers perform order operation. The electronic menu terminals can display information that restaurants desire to inform customers on a small liquid crystal display panel or a display screen. However, the customers need to operate the electronic menu terminals to order dishes. Since the order is placed via the electronic menu terminals, communication between restaurant attendants and customers is reduced and opportunities for the restaurant attendants to provide customer services is reduced.

### SUMMARY

It is an object of the present invention to inform customers of a large number of pieces of new information through a menu sheet while making the menu sheet easy to handle for the customers.

According to an aspect of the present invention, there is provided a menu sheet including a base sheet having a menu surface for writing a menu, an information display section that is attached to the base sheet and displays content of display data, a receiving section that receives display data transmitted by an information transmitting apparatus, a storing section that stores display data, and a control section that causes the storing section to store the display data received by the receiving section and causes the information display section to display the display data stored by the storing section.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram of an overview of an information delivery system;

FIG. 2 is a plan view of a menu sheet;

FIG. 3 is a block diagram of an electric configuration of respective sections of the menu sheet;

FIG. 4 is an external perspective view of electronic paper viewed from an information display surface side;

FIG. 5 is a diagram for explaining an example of a method of attaching the electronic paper to a base sheet;

FIG. 6 is a diagram for explaining another example of the method of attaching the electronic paper to the base sheet;

FIG. 7 is a diagram for explaining still another example of a method of attaching the electronic paper to the base sheet; and

FIG. 8 is a flowchart of a flow of processing executed by a CPU.

### DETAILED DESCRIPTION

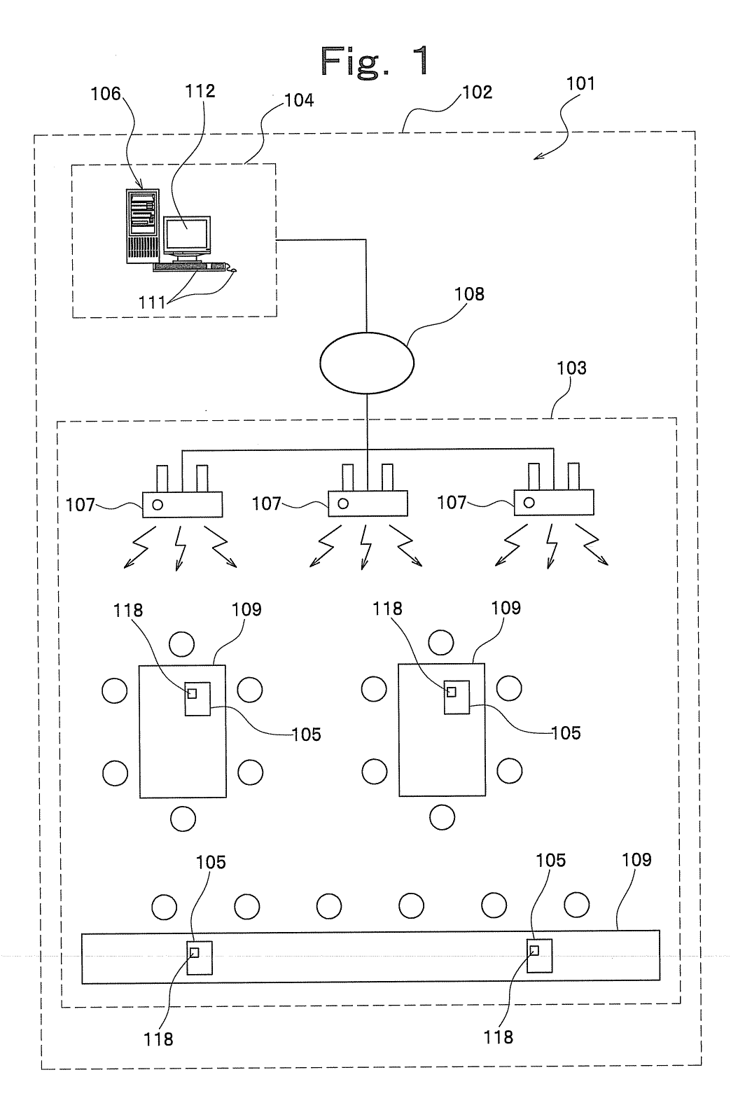

An embodiment of the present invention is explained with reference to FIGS. 1 to 8. This embodiment is an example of application of the present invention to menu sheets equipped on tables set in a customer seat area of a restaurant.

FIG. 1 is a schematic diagram of an overview of an information delivery system 101. A restaurant 102 includes plural areas. An example of the areas is a customer seat area 103 where customers enjoy eating and drinking. Another example of the areas is a backyard 104 where employees such as customer attendants come in and out. Still another example of the areas is a kitchen (not shown) where cooks perform cooking. In the customer seat area 103, menu sheets 105 and radio access points 107 are arranged. In the backyard 104, a computer 106 as an information transmitting apparatus is arranged. The computer 106 and the radio access points 107 are connected through a LAN network 108 in the restaurant 102. The menu sheets 105, the computer 106, and the radio access points 107 configure the information delivery system 101.

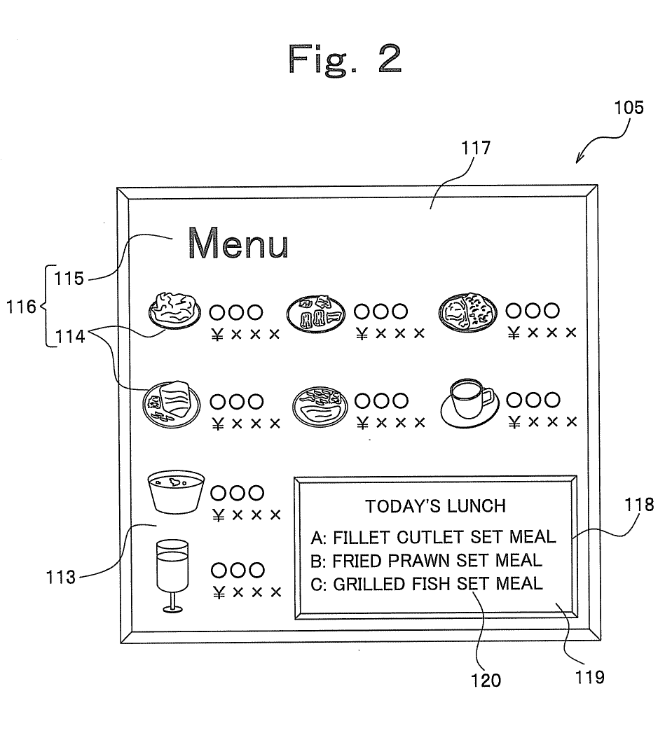

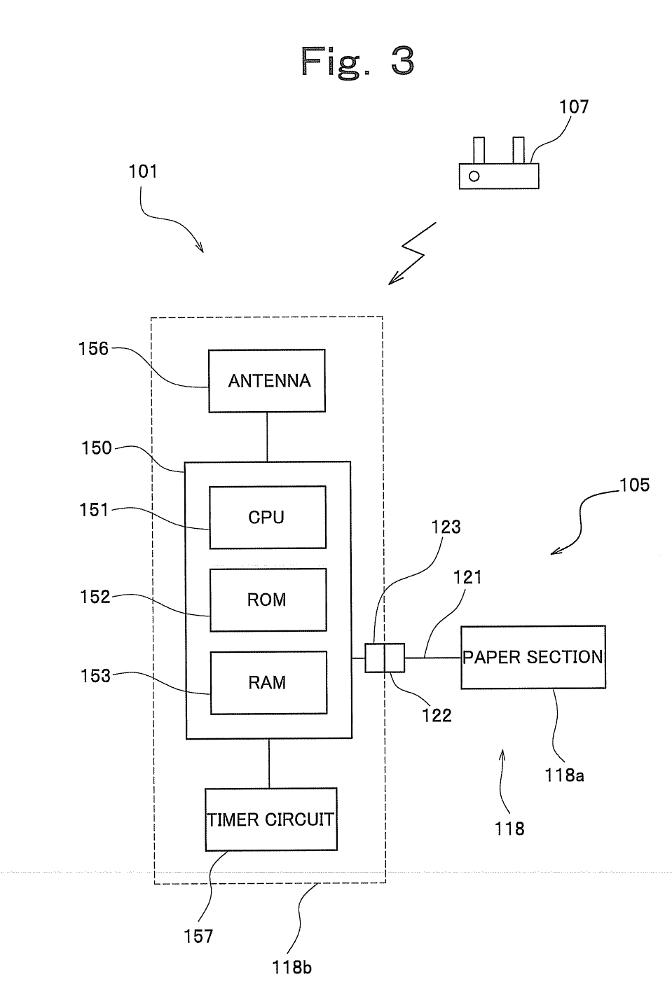

In the customer seat area 103, plural tables 109 for customers to enjoy eating and drinking are set. Each of the tables 109 is equipped with the menu sheet 105. The menu sheet 105 includes a base sheet 113 (see FIG. 2). Electronic paper 118 as an information display section, an antenna 156 (see FIG. 3) as a receiving section, and a microcomputer 150 (see FIG. 3) as a control section are attached to the base sheet 113.

The computer 106 arranged in the backyard 104 is a general computer. The computer 106 includes an input device 111 such as a keyboard and a pointing device, an output device 112 such as a display, and a hard disk (not shown). An operating system (OS), various driver programs, and application programs are installed in the hard disk. The computer 106 realizes processing conforming to the various programs installed in the hard disk. The application programs installed in the hard disk include a program for causing the computer 106 to realize a function of creating, on the computer 106, display data displayed on the electronic paper 118, a program for causing the computer 106 to realize a function of transmitting a control command for remotely operating display content displayed on the electronic paper 118, and a program for causing the computer 106 to realize a function of delivering the display data and the control command to the menu sheets 105 through the radio access points 107. According to the application programs, the computer 106 creates display data and transmits the created display data and the control command for the electronic paper 118 to the radio access points 107 through the LAN network 108.

The access points 107 arranged in the customer seat area 103 receive the display data and the control command transmitted by the computer 106 and output the display data and the control command. When the microcomputer 150 of the menu sheet 105 receives the display data via the antenna 156, the microcomputer 150 causes the electronic paper 118 to display the display data. When the microcomputer 150 receives the control command via the antenna 156, the microcomputer 150 controls display of the electronic paper 118.

FIG. 2 is a plan view of the menu sheet 105. The base sheet 113 having a rectangular shape is a base of the menu sheet 105. A material of the base sheet 113 is, for example, synthetic resin such as soft vinyl. In the base sheet 113, various menu items 114 provided to customers by the restaurant 102 and fixed information 116 including decoration 115 other than the menu items 114 are fixedly written on one side. The fixed information 116 is written by, for example, printing. In the base sheet 113 shown in FIG. 2, photographs, names, and prices of dishes (or drinks) are written as the menu items 114 and a character string “Menu” is written as the decoration 115. The menu items 114 and the decoration 115 configure a menu surface 117 that customers refer to in order to determine order items.

The electronic paper 118 attached to the menu surface 117 of the base sheet 113 is a display device having a thin flat shape. The electronic paper 118 is attached to the base sheet 113 with an information display surface 119, on which content of display data is displayed, faced in the same direction as the menu surface 117.

FIG. 3 is a block diagram of an electric configuration of respective sections of the menu sheet 105. The menu sheet 105 includes a control unit 118b. The control unit 118b houses the microcomputer 150, the antenna 156, a timer circuit 157, a power supply circuit (not shown), and a battery (not shown).

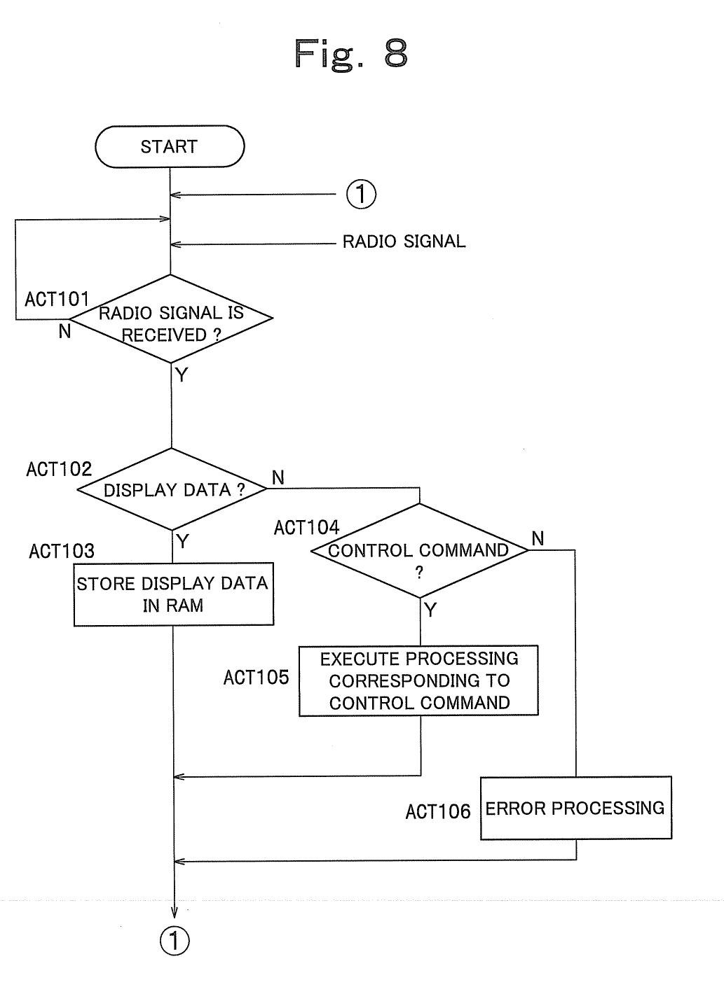

The microcomputer 150 includes a CPU 151, a ROM 152, and a RAM 153. The CPU 151 executes arithmetic processing. The ROM 152 stores data including various programs in advance. The programs stored by the ROM 152 include a program for causing the CPU 151 to execute processing explained later with reference to FIG. 8. The RAM 153 functions as a storing section that stores display data displayed on the information display surface 119 of the electronic paper 118.

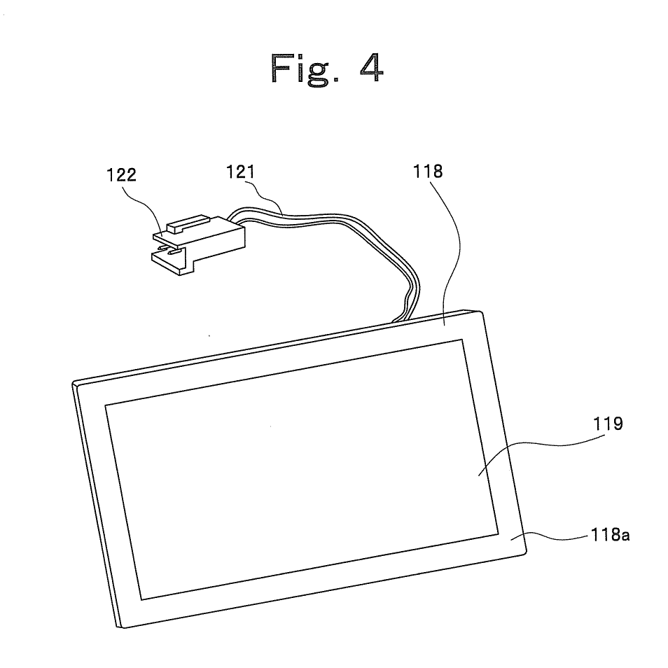

The microcomputer 150 is connected to a paper section 118a of the electronic paper 118 via an input and output circuit (not shown) and a connection cord 121. Details of the paper section 118a are explained later with reference to FIG. 4. One end of the connection cord 121 is attached to the electronic paper 118. The connection cord 121 has a connector 122 at the other end. The control unit 118b includes a terminal 123 connected to the connector 122. The control unit 118b supplies voltage to the paper section 118a via the connection cord 121.

The microcomputer 150 is connected to the antenna 156 via the input and output circuit (not shown). The antenna 156 is, as an example, a coil wound in a shape that can be housed in the control unit 118b. The microcomputer 150 receives a radio signal from the radio access point 107 via the antenna 156 and the input and output circuit (not shown). The antenna 156 and the microcomputer 150 function as a receiving section.

The microcomputer 150 is connected to the timer circuit 157 via the input and output circuit (not shown). The timer circuit 157 measures time. The time measurement by the timer circuit 157 is used for adjusting timing when the CPU 151 switches display data displayed on the information display surface 119 of the electronic paper 118 in the processing explained later with reference to FIG. 8.

The connection between the microcomputer 150 and the respective sections such as the paper section 118a may be bus connection.

When the microcomputer 150 receives, via the antenna 156, display data transmitted by the computer 106, the microcomputer 150 causes the RAM 153 to store the display data. The information display surface 119 of the electronic paper 118 displays, according to electric control, content of the display data stored by the RAM 153 as variable information 120. The content of the display data displayed by the information display surface 119 as the variable information 120 attracts a customer's attention in conjunction with the information of the menu items 114 and the like fixedly written on the base sheet 113. The variable information 120 displayed by the information display surface 119 of the electronic paper 118 forms the menu screen 117 together with the fixed information 116 (including the menu items 114 and the decoration 115) fixed written on the menu sheet 105. Customers refer to the variable information 120 in determining order items. The electronic paper 118 displays the variable information 120 on the base sheet 113 of the menu sheet 105. The variable information 120 shown in FIG. 2 is information concerning “today's lunch” that is changed everyday.

FIG. 4 is an external perspective view of the electronic paper 118 viewed from the information display surface 119 side. The electronic paper 118 is an electronic paper of a microcapsule type electrophoresis system. An entity of the electronic paper 118 of the microcapsule type electrophoresis system is the paper section 118a. The paper section 118a includes a transparent plastic substrate forming a protective layer, a transparent electrode, a microcapsule layer, a TFT (thin-film transistor) layer, and a back substrate stacked in order from the information display surface 119 side. In the microcapsule layer, spherical microcapsules storing white particles (e.g., titanium oxide particles) charged plus and black particles (e.g., carbon black particles) charged minus are laid in layers. In the TFT layer, lead wires in two directions orthogonal to each other are spread in a lattice shape. The lead wires in one direction (gate wires) are connected to a gate driver and the lead wires in the other direction (source wires) are connected to a source driver. Active elements are arranged at intersections of the lead wires. Drains of the active elements are connected to pixel electrodes. According to processing performed by the microcomputer 150 confirming to content of display data, the control unit 118b sends a control signal for controlling on and off of the active elements to the paper section 118a. The gate driver of the paper section 118a applies ON voltage to the gate wires according to the control signal. Consequently, the active elements changes to an ON state. The source driver of the paper section 118a applies voltage to the source wires. Consequently, voltage is applied to the pixel electrodes connected to the active elements in the ON state. The power supply circuit of the control unit 118b applies voltage common to respective pixels to the transparent electrode. In this way, an electric field is generated between the pixel electrodes and the transparent electrode. A voltage plus side attracts the black particles and a voltage minus side attracts the white particles. In short, according to the processing performed by the microcomputer 150, it is possible to control the active elements corresponding to desired dots forming a display image on the information display surface 119 to change a spherical surface on the information display surface 119 side of the microcapsule to black.

The electronic paper 118 is not limited to the electronic paper of the microcapsule type electrophoresis system. The electronic paper 118 may be electronic paper of an electronic particulate material system, an electronic paper of a liquid crystal system, or an electronic paper of an electro-wetting system. The menu sheet 105 may adopt, instead of the electronic paper 118, a display device that has small overall thickness and flexibility and consumes less power.

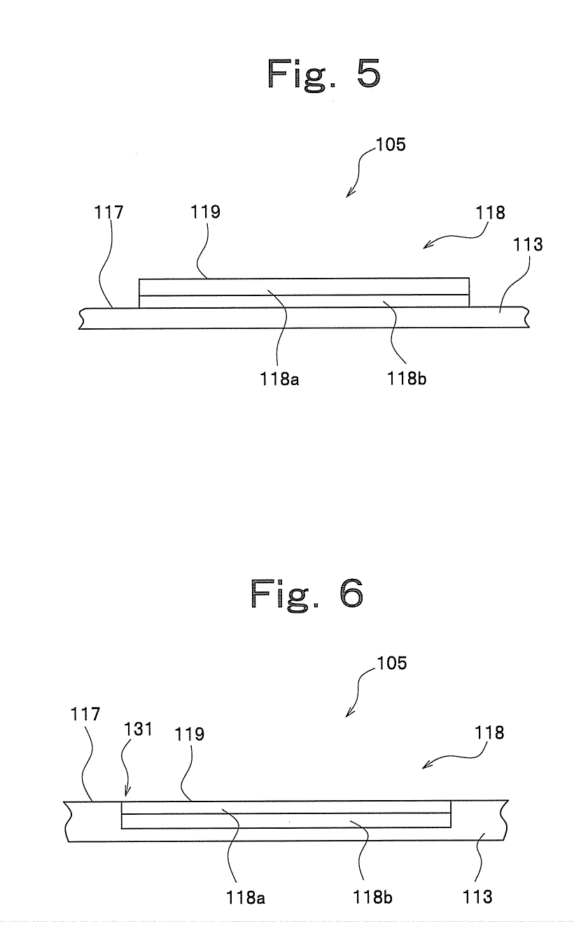

FIG. 5 is a diagram for explaining an example of a method of attaching the electronic paper 118 to the base sheet 113. In the example shown in FIG. 5, the control unit 118b having the same size as the electronic paper 118 is attached to the rear surface (a surface on the opposite side of the information display surface 119) of the paper section 118a of the electronic paper 118. The control unit 118b houses the antenna 156 (see FIG. 3), the microcomputer 150 (see FIG. 3), and the battery (not shown). The control unit 118b and the paper section 118a are stacked in this order on the menu surface 117 of the base sheet 113 and bonded by, for example, an adhesive.

FIG. 6 is a diagram for explaining another example of the method of attaching the electronic paper 118 to the base sheet 113. As shown in FIG. 6, a recess 131 having the same size as the electronic paper 118 is provided in the menu surface 117 of the base sheet 113. The electronic paper 118 having the control unit 118b attached to the rear surface is fit in the recess 131. As shown in FIG. 6, it is desirable that the menu surface 117 of the base sheet 113 and the information display surface 119 of the electronic paper 118 are flush with each other.

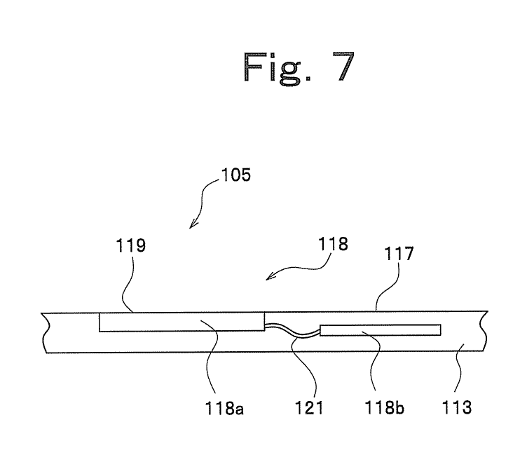

FIG. 7 is a diagram for explaining still another example of the method of attaching the electronic paper 118 to the base sheet 113. As shown in FIG. 7, the control unit 118b may be embedded in the base sheet 113 without being superimposed on the paper section 118a of the electronic paper 118. The control unit 118b may be arranged to be exposed to the surface of the base sheet 113. In any case, with the attaching method shown in FIG. 7, it is possible to reduce the thickness of the base sheet 113 to be smaller than that in the examples shown in FIGS. 5 and 6.

In all the examples shown in FIGS. 5 to 7, the electronic paper 118 may be protected by superimposing a transparent protective sheet (not shown) on the menu surface 117 of the base sheet 113 and the information display surface 119 of the electronic paper 118.

FIG. 8 is a flowchart of a flow of processing executed by the CPU 151. The CPU 151 executes, while power supply by the battery (not shown) is received, the processing according to the description of a program stored by the ROM 152 and determines whether a radio signal is received via the antenna 156 (Act 101).

If the CPU 151 determines that the radio signal is received (Yes in Act 101), the CPU 151 subsequently determines whether content of the radio signal is display data that the CPU 151 should cause the electronic paper 118 to display (Act 102). If the CPU 151 determines that the content of the radio signal is the display data that the CPU 151 should cause the electronic paper 118 to display (Yes in Act 102), the CPU 151 causes the RAM 153 to store the display data (Act 103) and returns the processing to Act 101. In Act 103, the CPU 151 may cause the RAM 153 to store the display data and control the electronic paper 118 to display the content of the display data on the electronic paper 118.

On the other hand, if the CPU 151 determines that the content of the radio signal is a control command indicating content of processing that the CPU 151 should perform (No in Act 102 and Yes in Act 104), the CPU 151 executes processing corresponding to the control command (Act 105) and returns the processing to Act 101. The processing performed by the CPU 151 according to the control command includes, as an example, processing in which the CPU 151 erases display data stored by the RAM 153 and processing in which the CPU 151 changes time interval in sequentially switching and displaying plural display data stored by the RAM 153. These kinds of processing are included in the program stored by the ROM 152 and is associated with the control command in advance. When the CPU 151 determines that the control command is input, the CPU 151 executes the processing corresponding to the control command.

When the content of the radio signal is neither the display data nor the control command (No in Act 102 and No in Act 104), the CPU 151 executes error processing for controlling the electronic paper 118 to perform error display on the information display surface 119 (Act 106) and returns the processing to Act 101.

Besides the processing explained above with reference to FIG. 8, the CPU 151 controls, on the basis of the program stored by the ROM 152, the electronic paper 118 to display the display data stored by the RAM 153 on the information display surface 119. The CPU 151 causes, on the basis of the time measurement by the timer circuit 157, the electronic paper 118 to sequentially switch and display the plural display data stored by the RAM 153 at a time interval set in advance.

As explained above, the microcomputer 150 causes the RAM 153 to store the display data received via the antenna 156 and controls the electronic paper 118 to display the display data stored by the RAM 153 on the information display surface 119.

In the restaurant 102 that introduces the information delivery system 101, an employee such as a customer attendant can create, using the computer 106 arranged in the backyard 104, display data indicating content that the employee desires to inform customers. Examples of the content include today's specials, introduction of today's recommendation, information concerning producing districts of materials of dishes provided to customers, a guide to an event performed by the restaurant 102, various advertisements, a URL of a Web site of the restaurant 102, a two-dimensional code of the URL, and a message of gratitude from a manager to customers. The program installed in the computer 106 realizes the creation of display data.

After creating the display data indicating the content that the employee desires to inform customers, the employee delivers the created display data by operating the computer 106. The program installed in the computer 106 realizes delivery operation. According to the delivery operation, the computer 106 transmits the display data to the radio access point 107 through the LAN network 108. The radio access point 107 outputs the display data as a radio signal.

When the radio signal reaching the antenna 156 included in the menu sheet 105 is the display data, the RAM 153 stores the display data. Thereafter, the information display surface 119 of the electronic paper 118 displays the display data stored by the RAM 153. The display data displayed by the information display surface 119 attracts attention of a customers who looks at the menu sheet 105 in conjunction with the fixed information 116 (including the menu items 114 and the decoration 115) on the menu surface 117 of the menu sheet 105.

The employee can operate the computer 106 to deliver the control command for controlling the electronic paper 118. According to the delivery operation, the computer 106 transmits the control command to the radio access point 107 through the LAN network 108. The radio access point 107 outputs the control command as a radio signal. When the control command output by the radio access point 107 reaches the antenna 156 included in the menu sheet 105, the microcomputer 150 performs processing corresponding to the control command.

For example, when the employee creates and deliver display data indicating a text “today's lunch, A: fillet cutlet set meal, B: fried prawn set meal, C: grilled fish set meal” using the computer 106, the information display surface 119 of the electronic paper 118 displays “today's lunch, A: fillet cutlet set meal, B: fried prawn set meal, C: grilled fish set meal” as shown in FIG. 2. The display of the information display surface 119 attracts the customer's attention in conjunction with the menu items 114 and the decoration 115. Therefore, the customer can determine, with reference to information concerning today's specials such as “today's lunch” besides the usual menu items 114 fixed written on the base sheet 113, menu items that the customer desires to order.

With the menu sheet 105 according to this embodiment, the electronic paper 118 on the menu surface 117 of the menu sheet 105, which customers look at to determine order items, displays display data transmitted by the computer 106. Therefore, the menu sheet 105 is easy for the customers to handle and can inform the customers of a larger number of pieces of new information.

The customers can determine order items without feeling the menu sheet 105 heavy. Since power consumed while the electronic paper 118 maintains display content is small and the number of times of battery replacement is small, maintenance and management of the menu sheet 105 do not impose burden on the shop.

Obviously, numerous modifications and variations of the present invention are possible in light of the above teachings. It is therefore to be understood that within the scope of the appended claims, the invention may be practiced otherwise than as specifically described herein.

What is claimed is:

1. A menu sheet comprising:
a base sheet having a menu surface for writing a menu;
an information display section that is attached to the base sheet and displays content of display data;
a receiving section that receives display data transmitted by an information transmitting apparatus;
a storing section that stores display data; and
a control section that causes the storing section to store the display data received by the receiving section and causes the information display section to display the display data stored by the storing section.

2. The menu sheet according to claim 1, wherein the information display section is an electronic paper.

3. The menu sheet according to claim 2, wherein the electronic paper comprises:
a control unit that houses the receiving section, the storing section, and the control section and is attached to the menu surface of the base sheet; and
a paper section that has an information display surface for displaying content of display data, a surface on an opposite side of the information display surface being attached to the control unit.

4. The menu sheet according to claim 2, further comprising a recess provided in the menu surface of the base sheet, wherein
the electronic paper includes:
a control unit that houses the receiving section, the storing section, and the control section; and
a paper section that has an information display surface for displaying content of display data, the control unit being attached to a surface on an opposite side of the information display surface and fit in the recess.

5. The menu sheet according to claim 2, wherein the electronic paper comprises:
a control unit that houses the receiving section, the storing section, and the control section and is embedded in the base sheet; and
a paper section that has an information display surface for displaying content of display data, the paper section being attached to the base sheet in a position not overlapping the control unit.
